(19) United States
(12) Patent Application Publication
(10) Pub. No.: US 2018/0040067 A1
(43) Pub. Date: Feb. 8, 2018

(54) DEVICE, SYSTEM, METHOD, AND COMPUTER MEDIUM FOR PROVIDING PRICE EVALUATION ON FIXED-INCOME SECURITIES IN ODD LOT MARKET AND IMPROVING MARKET CONFIDENCE REGARDING THE SAME

(71) Applicant: BondDesk Group LLC, New York, NY (US)

(72) Inventors: Jan MAYLE, Bernardsville, NJ (US); Ken HOFFMAN, Chatham, NJ (US); Steven Jay SHAW, Chester, NJ (US); P. Howard EDELSTEIN, New York, NY (US)

(73) Assignee: BondDesk Group LLC, New York, NY (US)

(21) Appl. No.: 15/466,441

(22) Filed: Mar. 22, 2017

Related U.S. Application Data
(63) Continuation of application No. 13/840,737, filed on Mar. 15, 2013, now abandoned.

(51) Int. Cl. G06Q 40/04

(52) U.S. Cl. CPC G06Q 40/04

(57) ABSTRACT

A method, device, system, and computer medium for providing odd lot pricing evaluation of a security using market-acceptable odd lot pricing range (OLP range) are provided. For example, a price quote for an odd lot transaction or potential transaction of a security is received. An Odd Lot Pricing range (OLP range) for the quote is searched. If the OLP range is found for the quote, the quoted price is compared against the OLP range. Based on the comparison, the quote can be verified or indicated as requiring further review.

### CROSS REFERENCE TO RELATED APPLICATIONS

This application is a continuation of U.S. patent application Ser. No. 13/840,737, filed on Mar. 15, 2013, which is hereby incorporated by reference in its entirety.

### FIELD OF THE INVENTION

The present invention relates to a device, system, method, and computer-readable medium for providing price evaluation on fixed-income securities in the odd lot market and thereby improving market confidence with odd-lot trades on a fixed-income security, and the following description is made with reference to this field of application for convenience of explanation only.

### BACKGROUND OF THE INVENTION

An Alternative Trading System (“ATS”) enables investors to trade fixed income securities such as municipal, corporate, Treasury, agency, convertible and mortgage bonds and certificates of deposit. There are well over two million separate securities in the United States fixed income market, which can range from a highly liquid Treasury bond that trades billions of dollars in volume each day to a very illiquid municipal bond that may never trade in a given year.

Generally, quotes from a multitude of broker-dealers (“Liquidity Providers”) are aggregated, and based on the aggregated data the ATS enables any of the following market participants —traders, financial advisors, registered investment advisors, buy-side institutions and individual investors (“Liquidity Takers”)—to search for bonds, view the quotes provided by Liquidity Providers, and ultimately execute trades.

ATSs assist users with fixed income price discovery, as they enable Liquidity Takers to compare all of the quotes from Liquidity Providers in one place so they can help ensure they are receiving the best price and “best execution” for their trade.

Liquidity takers can also compare yields they will receive across different fixed income securities. For example, one could compare the after-tax yield of a corporate bond to that of a municipal bond and determine which bond offered a better potential return. These yields are inversely impacted by the price at which a bond trade is executed, and therefore it is crucial for investors to know they are receiving a fair price so they can make the most informed investment decisions.

Both the Municipal Securities Rulemaking Board (MSRB) and Financial Industry Regulatory Authority (FINRA) have stated that a key factor that dealers must consider is the yield on comparable securities. The MSRB stated in its Review of Dealer Pricing Responsibilities Notice 2004-3 (Jan. 26, 2004) “The most important factor in determining whether the aggregate price to the customer is fair and reasonable is that the yield should be comparable to the yield on other securities of comparable quality, maturity, coupon rate, and block size then available to the market.”

Users may see the prices offered by all dealers in a given bond as well as, in the case of securities with regulatory trade reporting requirement (currently, municipals, corporates and agencies), historical trades in that bond. For corporate and agency bonds, the trades are reported within fifteen minutes to the FINRA Trade Reporting and Compliance Engine (TRACE). For municipals, trades are reported to the MSRB through the real-time transaction reporting system (RTRS). These historical trades can be viewed by clients on ATS or by the public on FINRA and MSRB's websites and other websites such as investinginbonds.com.

When bonds are regularly traded and have multiple dealers providing quotes, investors have many data points and market observations to validate the price at which they are about to execute a trade. In fixed income, however, there are vast differences in liquidity and trade volume among asset classes and different securities, as will be explained in detail below.

FIGS. 1A and 1B illustrate an example of a corporate bond (Goldman Sachs corporate bond) and a municipal bond (Franklin, Tenn. revenue bond) having differences in liquidity.

“Depth of Book” refers to a list of offers or bids that a trading venue uses to record the interest of buyers and sellers in a security—in this case, the Goldman Sachs corporate bond and the Franklin, Tenn. revenue bond. The graphs on the right side respectively plot the recently-reported trades of, in this case, the Goldman Sachs corporate bond and the Franklin, Tenn. revenue bond. The Goldman Sachs corporate bond had nine bid-side quotes and ten offer-side quotes, as well as approximately twenty trades reported to TRACE during the preceding trading day. In contrast, the Franklin, Tenn. revenue bond had only one offer-side quote and no bid-side quotes, with one trade taking place in the preceding trading day.

In this case, one could see how an investor might be more comfortable investing in the Goldman corporate bond due to the greater level of liquidity and recent trading activity.

In bond trades, a “round-lot” generally refers to a quantity of bonds that are worth at least $1,000,000 in total in principal whereas an “odd-lot” refers to a quantity of bonds that are worth less than $1,000,000 in total in principal. The round-lot market is generally considered to be a “tighter” market than odd lot, characterized by narrower bid-ask spreads and the lack of sales commissions on trades. Further, the round lot market has more market professional participants and reference values publicly available than the odd lot market. Accordingly, there is often more uncertainty around trade execution of fixed income asset classes in the odd-lot market than in the round lot market.

### SUMMARY OF THE INVENTION

<Problem Identified by Inventors>

Due to the disparity in liquidity and trading volumes across the fixed income marketplace, a number of companies have tried to calculate and license evaluated prices to establish the value of different securities. These evaluated prices may be created through mathematical formulas that incorporate, among other things, round-lot (at least $1,000,000 in principal) trade data and dealer quotes, security master data, and yield curves to price millions of different fixed income securities.

While there is guidance from regulators on what can help ensure best execution, there is not currently an agreed-upon procedure that firms can consistently apply. As a result, firms have taken different ad hoc steps in complying with best-execution requirements. For example, some firms may reject all trades that are the day's high or low price even if it was the best price available at the given time since they do not want the trade to be deemed an outlier and audited by FINRA or MSRB. Others may reject trades if there is a wide disparity between the quoted price and the evaluated price even though the evaluated price is for the round-lot market, priced at the end of the preceding day and not necessarily relevant to the odd lot trades being executed.

According to FINRA and MSRB, approximately 85% of municipal and corporate bond trades are in sizes of less than $1,000,000 in principal amount, or approximately 70,000 trades every day. In addition, there are tens of millions of bond positions of less than $1,000,000 in principal amount. While there are millions of individual fixed income securities, only Approximately 55,000 have live posted quotes and, within less liquid asset classes such as municipal bonds, there is not a competitive two-sided quoted market.

Due to the varying degrees of liquidity, evaluated prices are used as a way to independently verify the quality of the market prices investors see. These evaluated prices are currently tailored to the round-lot market and, therefore, are not generally relevant to the odd-lot market.

In addition, since evaluated prices are in the form of a singular bid- and ask-side price, it is difficult for firms to determine how far away from the evaluated price is acceptable given the asset class and specific security.

There are also myriad uses for evaluated prices, including pricing traders' books, calculating net asset values, calculating client statement values and helping determine whether trades were executed at a fair price. Calculating the value of a bond in a month-end client statement is a completely different use case than determining whether a security in fast-moving markets is fairly priced at a specific time on one trading day within that month, and a new product is needed to address the foregoing problem.

A key attribute of the fixed income market is the breadth of asset classes and different securities that can fit well into different clients' investment objectives. For example, a more risk-averse investor nearing retirement might prefer the security of United States Treasury bonds, while an income investor in a high tax bracket might prefer municipal bonds. These investment alternatives can grow and flourish to the extent investors have confidence in the prices at which their trades are executed. If, however, market participants lack confidence in receiving fair pricing in the market, trading volumes will gravitate further to the most highly liquid securities. Over time, this will reduce choice among investors and limit crucial investment alternatives for everyone.

<Solutions Provided by Inventors>

The present disclosure discusses various ways to implement a device, a system, a method and a computer-readable medium for evaluating odd-lot market using odd lot pricing (OLP) data to improve the market and investor confidence.

According to the present disclosure, there may be provided a method for providing odd lot pricing evaluation of a security, using a computing device including a processor, the method comprising: receiving by a processor a price quote for an odd lot transaction or a potential transaction of a security; searching by a processor Odd Lot Pricing (OLP) data for the quote, the OLP data including an OLP range; comparing by a processor the quoted price against the OLP range; and transmitting by a processor a result based on the comparison.

The result may be that the quote is verified, that the quote needs further review, or that there is insufficient data regarding the quote.

The result may indicate that the quote is verified if the quoted price is within the OLP range.

The result may indicate that the quote needs further review if the quoted price is outside the OLP range.

The result may indicate that there is insufficient data regarding the quote if no OLP range is available with regard to the quote.

The quoted price may be either an offer price to sell a security or a bid price to buy a security.

If the quoted price is an offer price to sell a security, the quoted price is within the OLP range if the quoted price is between an upper range price and a lower range price of the OLP range, or lower than the lower range price of the OLP range, and the quoted price is outside the OLP range when the quoted price is higher than the upper range price of the OLP range.

If the quoted price is a bid price to buy a security, the quoted price is within the OLP range if the quoted price is between an upper range price and a lower range price of the OLP range, or higher than the upper range price of the OLP range, and the quoted price is outside the OLP range when the quoted price is lower than the lower range price of the OLP range.

The method may further comprise evaluating by a processor recently-reported trade data similar to the quoted transaction or potential transaction, wherein the result is based on both the evaluation of the recently-reported trade data and the comparison of the quoted price against the OLP range.

The recently-reported trade data may be evaluated to determine whether there has been a trade of the quoted security executed on the same day with an executed price being within a predetermined tolerance of the quoted price.

The result may indicate that the quote is verified if (i) the quoted price is within the OLP range and there is a trade executed on the same day within the predetermined tolerance of the quoted price, or (ii) the quoted price is within the OLP range and there is no trade executed on the same day.

The result may indicate that the quote needs further review if (i) the quoted price is outside the OLP range, or (ii) the quoted price is within the OLP range and there is a trade executed on the same day whose executed price is outside the predetermined tolerance of the quoted price.

The predetermined tolerance value may be less than 10%, and may be adjusted by a user.

The recently-reported trade data may be evaluated to determine whether there has been a trade executed on the same day or within a predetermined number of past days with an executed price being within a predetermined tolerance of the quoted price.

The result may indicate that the quote is verified if any one of the following conditions is satisfied: (i) the quoted price is within the OLP range and there is a trade executed on the same day within the predetermined tolerance of the quoted price, (ii) the quoted price is within the OLP range and there is no trade executed on the same day, (iii) the quoted price is within the OLP range and there is a trade executed within the predetermined number of past days within the predetermined tolerance of the quoted price, (iv) the OLP range is not available and there is a trade executed on the same day within the predetermined tolerance of the quoted price, or (v) the OLP range is not available and there is a trade executed within the predetermined number of past days within the predetermined tolerance of the quoted price.

The result may indicate that the quote needs further review if any one of the following conditions is satisfied: (i) the quoted price is outside the OLP range, (ii) the quoted price is within the OLP range and there is a trade executed on the same day whose executed price is outside the predetermined tolerance of the quoted price, (iii) the quoted price is within the OLP range and there is a trade executed within the predetermined number of past days outside the predetermined tolerance of the quoted price, (iv) the OLP range is not available and there is a trade executed on the same day outside the predetermined tolerance of the quoted price, or (v) the OLP range is not available and there is a trade executed within the predetermined number of past days outside the predetermined tolerance of the quoted price.

The result may indicate that there is insufficient data regarding the quote if no OLP range is available with regard to the quoted transaction or potential transaction and there is no reported trade executed within the predetermined number of past days.

The predetermined tolerance may be less than 10% and the predetermined number of past days is less than 10 days, and each of these values may be modified by a user.

The OLP range for the quoted transaction or potential transaction may be based on at least one of round-lot trade data, dealer quotes, security master data, and yield curves. The yield curves may be used to price millions of different fixed income securities.

The OLP range may be received from a third party and locally stored in a server.

The method may further comprise providing by a processor information regarding the quote including the quoted price to a third party; and receiving by a processor an OLP range for the quote from the third party.

The OLP data for the quote may comprise an upper range price, a lower range price, and an evaluated price.

The OLP range for the quoted transaction or potential transaction may be calculated differently depending on the quoted transaction size or quoted potential transaction size.

The method may be used by at least any one of a financial advisor, an investment representative, a liaison trader, a trader, a compliance person, an individual investor, a regulator, a trading manager, or a trading deskhead.

The price quote may be received by a user using an input device, and the evaluation result may be displayed for the user.

The result and OLP data may be displayed together on a same screen.

Either or both the result and OLP data may be transmitted on an API or as a network message.

Each result may be associated with a distinct graphical icon or graphical representation.

The display may display a graphical representation, where an upper range price of the OLP range, a lower range price of the OLP range and the quoted price are each marked with respect to that graphical representative.

The result and the OLP data may be displayed together in a hover screen, an overlay screen, or any other type of screen.

According to the present disclosure, there may be provided a method for providing odd lot pricing evaluation of a security, using a computing device including a processor, the method comprising: accepting from a user via an input device a price quote for an odd lot transaction or potential transaction of a security; transmitting the quoted price to a server for evaluation on the quote; receiving an evaluation result from the server; and displaying the evaluation result to the user.

According to the present disclosure, there may be provided a method for setting up an offer for an odd lot trade of a security, using a computing device including a processor, the method comprising: accepting by a processor an offer price from a user for an odd lot trade of a security; transmitting by a processor the offer price to a server; receiving by a processor a result from the server, the result being one of that the offer is verified, that the offer needs further review, and that there is insufficient data regarding the offered trade; transmitting by a processor the offer to a market place, if the offer is verified; and accepting again from the user a different offer price or a confirmation of the offer price before transmitting the offer to the market place, if the offer needs further review.

The market place may comprise an alternative trading system (ATS).

According to the present disclosure, there may be provided a system for providing odd lot pricing evaluation of a security, comprising a central data server and a plurality of broker-dealer systems each configured to communicate with the central server, the central server configured to evaluate a quote received from at least one of the broker-dealer systems and transmit an evaluation result to at least one of the broker-dealer systems. The central server is configured to perform: receiving a quote on a security; evaluating the quote using an OLP range; generating an evaluation result by comparing the quote against the OLP range. At least one of the broker-dealer systems is configured to perform: sending a request for a quote to a market place; receiving a quote from at least another one of the broker-dealer systems via the market place; sending the received quote to the central server for evaluation; receiving an evaluation result on the received quote from the central server; and rejecting the received quote based at least on the evaluation result received from the central server. At least another one of the broker-dealer systems is configured to perform: receiving a request for a quote via the market place; creating a quote in response to the request; sending the created quote to the central server for evaluation; receiving an evaluation result on the created quote from the central server; and sending the created quote to the market place based at least on the evaluation result received from the central server.

A broker-dealer system may comprise a server or a terminal including a processor configured to execute a computer program. The terminal may be implemented based on the central server or connected to the same network as the central server.

An evaluation result generated by the central server may indicate at least one of that the quote is in the OLP range, outside the OLP range, or OLP range is not available for the quote.

At least one of the broker-dealer systems may reject the received quote if the evaluation result received from the central server indicates that the received quote is outside the OLP range.

At least one of the broker-dealer systems may send the received quote to a reviewer if the evaluation result received from the central server indicates that the received quote is in the OLP range.

At least another one of the broker-dealer systems may send the created quote to the market place if the evaluation result received from the central server indicates that the created quote is in the OLP range.

At least another one of the broker-dealer systems may allow the created quote to be updated if the evaluation result received from the central server indicates that the created quote is outside the OLP range.

According to the present disclosure, there may be provided a computing device including a processor for providing odd lot pricing evaluation of a security, the device comprising: a receiving unit that receives a price quote for an odd lot transaction or a potential transaction of a security; a searching unit that searches Odd Lot Pricing (OLP) data for the quote, the OLP data including an OLP range; a comparing unit that compares the quoted price against the OLP range; and a transmitting unit that transmits a result based on the comparison.

According to the present disclosure, there may be provided a computing device including a processor for providing odd lot pricing evaluation of a security, the device comprising: an input device that accepts from a user a price quote for an odd lot transaction or potential transaction of a security; a transmitting unit that transmits the quoted price to a server for evaluation on the quote; a receiving unit that receives an evaluation result from the server; and a display unit that displays the evaluation result to the user.

According to the present disclosure, there may be provided a computing system or a computing device including a processor, the system or device comprising: an input unit that accepts an offer price from a user for an odd lot trade of a security; a transmitting unit that transmits the offer price to a server; a receiving unit that receives a result from the server, where the transmitting unit transmits the offer to an alternative trading system, if the offer is verified, and the input unit accepts from the user a different offer price or a confirmation of the offer price before transmitting the offer to the alternative trading system, if the offer needs further review.

### BRIEF DESCRIPTION OF THE DRAWINGS

The characteristics and advantages of the device, system, method, and computer-readable medium for providing price evaluation on fixed-income securities in the odd lot market and thereby improving market confidence with odd-lot trades on a fixed-income security, according to the present disclosure, will be explained with reference to the following description of embodiments thereof given by way of indicative and non-limiting example with reference to the annexed drawings, in which:

FIGS. 1A and 1B show an example of a corporate bond and a municipal bond having differences in liquidity;

FIG. 2 schematically shows an example of a process flow chart for evaluating a price quote on a security using OLP data, according to the present disclosure;

FIG. 3 shows an example of a graphic image of an OLP range that may be displayed in conjunction with an evaluated quote, according to the present disclosure;

FIG. 4 shows an example of an evaluation table, with each evaluation result associated with a graphical representation, according to the present disclosure;

FIG. 5 schematically shows an example of a process flow chart for integrating OLP data with market check functionality, according to the present disclosure;

FIG. 6 shows an example of an evaluation table based on results from both the market check and OLP check, according to the present disclosure;

FIG. 7 shows an example of a screen displaying at least one of a OLP check result, a market check result and an evaluated quote, according to the present disclosure;

FIG. 8 shows an example of a screen displaying a bond-offering search result with at least one of a OLP check result, a market check result and an evaluated quote, according to the present disclosure;

FIG. 9 shows an example of a screen displaying a list of one or more of quotes with at least one of a OLP check result, a market check result and an evaluated quote, according to the present disclosure;

FIG. 10 shows an example of a screen displaying detail information of a security with at least one of a OLP check result, a market check result and an evaluated quote, according to the present disclosure;

FIG. 11 shows another example of a screen displaying detail information of a security with at least one of a OLP check result, a market check result and an evaluated quote, according to the present disclosure;

FIG. 12 shows an example of a process flow chart for integrating OLP check into trade monitoring service (TMS) test, according to the present disclosure;

FIG. 13 shows an example of a screen displaying a ‘failed’ result from OLP check test, according to the present disclosure;

FIG. 14 is an example of a screen displaying an offering setup for creating a quote with at least one of a OLP check result, a market check result and an evaluated quote, according to the present disclosure;

FIG. 15 is an example of a screen for a position manager displaying a list of open quotes with at least one of a OLP check result, a market check result and an evaluated quote, according to the present disclosure;

FIG. 16 shows an example of a process flow chart for setting up a quote or an offering using the OLP check functionality, according to the present disclosure;

FIG. 17 shows an example of a process flow chart for requesting for a quote and responding to the request, according to the present disclosure; and

FIG. 18 schematically shows an example of an odd lot retail pricing system, according to the present disclosure.

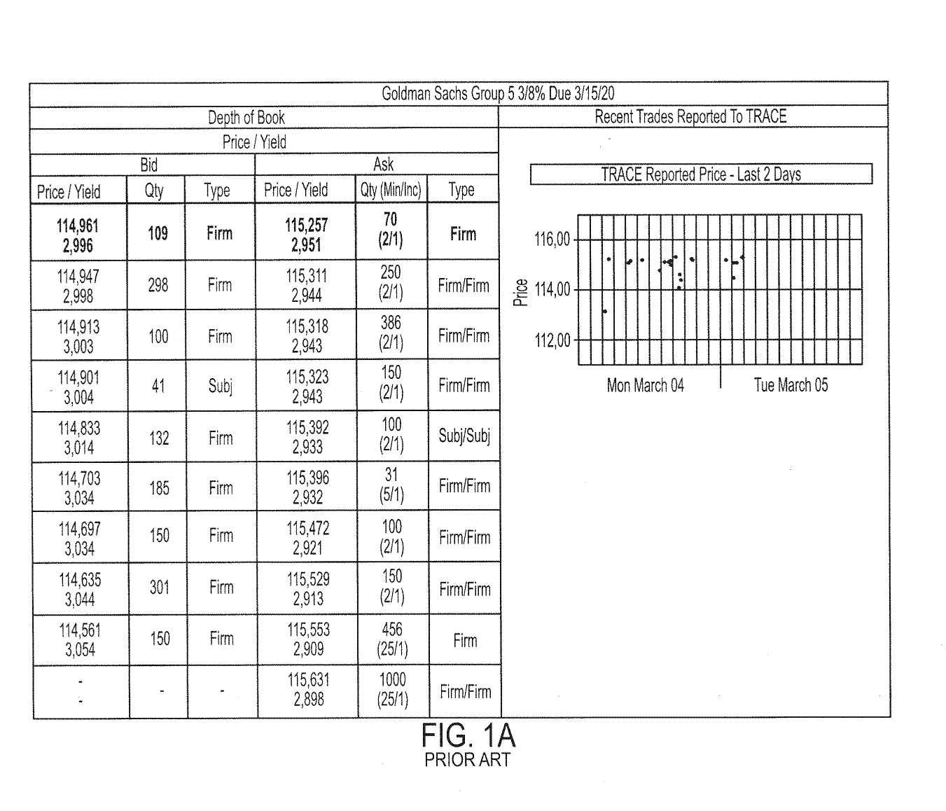

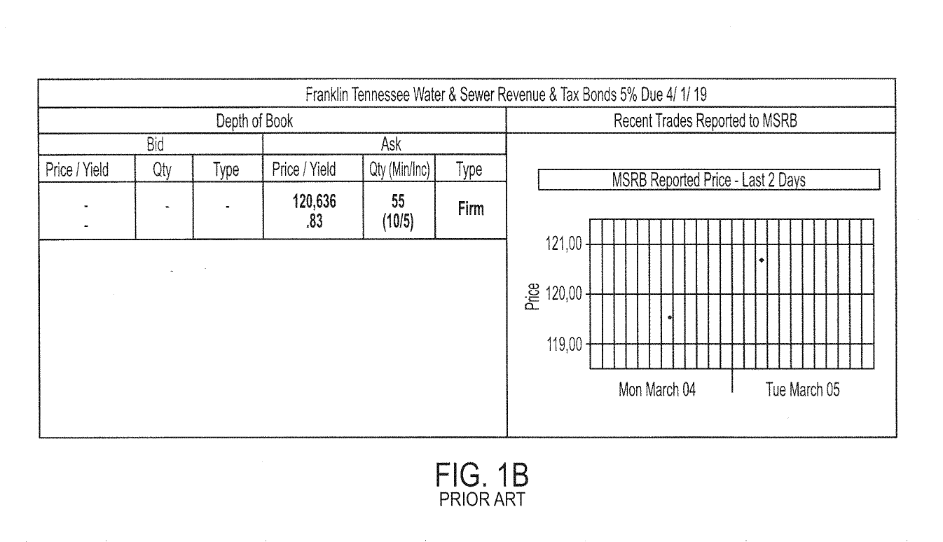

### DETAILED DESCRIPTION OF THE INVENTION

One of representative examples of a technological concept of the present disclosure will be described more fully hereinafter with reference to the accompanying drawings, in which illustrative embodiments of the present disclosure are shown. These examples may, however, be embodied in many different forms and should not be construed as limited to the embodiments set forth herein; rather, these embodiments are provided so that this disclosure will be thorough and complete, and will fully convey the scope of the claims to those skilled in the art. Like numbers refer to like elements throughout. As used herein, the term “and/or” includes any and all combinations of one or more of the associated listed items.

It will be understood that, although the terms first, second, etc. may be used herein to describe various elements, these elements should not be limited by these terms. These terms are only used to distinguish one element from another element. Thus, a first element discussed below could be termed a second element without departing from the scope of the present disclosure.

The terminology used herein is for the purpose of describing particular embodiments only and is not intended to be limiting of the claims. Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As will be appreciated by one of skill in the art, the present disclosure may be embodied as a method, data processing system, or computer program product. Furthermore, the present disclosure may take the form of a computer program product on a computer-usable storage medium having computer-usable program code embodied in the medium. Any suitable computer readable medium may be utilized including hard disks, CD-ROMs, optical storage devices, a transmission media such as those supporting the Internet or an intranet, or magnetic storage devices.

Computer program code for carrying out operations of the embodiments of the present disclosure may be written in an object oriented programming language such as Java®, Smalltalk or C++. However, the computer program code for carrying out operations of the embodiments of the present disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

The present disclosure is described in part below with reference to flow chart illustrations and/or block diagrams of methods, apparatus (systems) and computer program products according to embodiments of the present disclosure. It will be understood that each block of the flow chart illustrations and/or block diagrams, and combinations of blocks in the flow chart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flow chart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flow chart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flow chart and/or block diagram block or blocks.

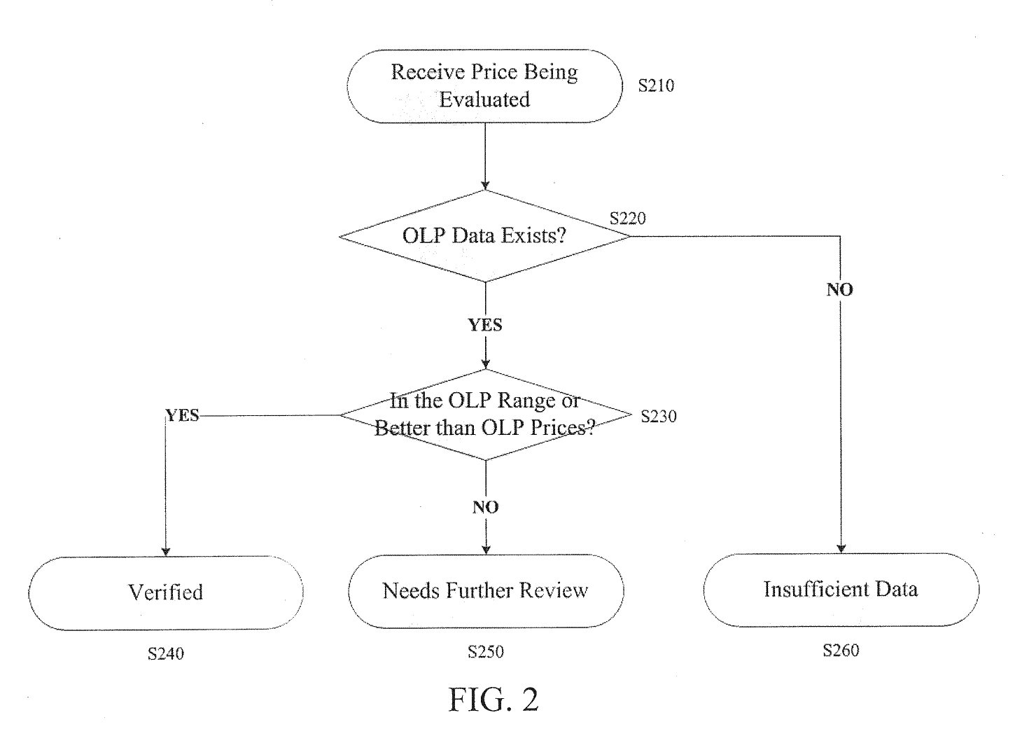

Embodiments of the present disclosure will now be described with respect to FIGS. 2 through 18 below. Embodiments provide methods, systems and computer program products for evaluating a security in the odd lot market using an odd-lot market pricing measure (“Odd-Lot Price” or “OLP”) to improve the investor confidence.

This effort may also help regulators and compliance departments evaluate trade execution quality in a more consistent manner.

Despite existing price tools, Financial Advisors (FAs) continue to lack confidence in the pricing they see on trading workstations. This is made worse by the fact that their trading desk often rejects orders they place against another firms inventory for “price off the market” reasons. F As often feel they cannot trust another firms inventory and it leads them to trade even more with their own firms trading desk thereby limiting their options.

For liquidity providers, Traders need to know that what FAs are being told is the fair price or fair price range of the security. All existing third-party sources of pricing information are for institutional bond markets. The OLP will be the first third-party pricing information available for the retail bond market. Having an OLP would be particularly valuable in the more illiquid retail markets lacking in disclosed and executable bids and offers. Armed with this new benchmark, traders, brokers, financial advisors, and individual investors will have a market-validated reference to guide and inform price discussions.

A new “OLP” system, a method and a device regarding the same, according to the present disclosure, can positively affect the business practices in at least the following three areas: wealth management, capital markets, and compliance. For wealth management, it may result in, for example, having fewer rejected trades, more liquidity and better markets provided to customers, and improved retail client expectations and communication. For capital markets, it may result in, for example, having better defined “rules of the road”, improved relationship between the trading desk and financial advisors, and counterparties being more willing to trade with each other. For compliance, it may result in, for example, having an easier and more standardized compliance procedure with respect to best execution rules (e.g., FINRA rule 531 0), as compliance and regulators may use the same “playbook” to evaluate pricing.

<OLP Data>

OLP data may be considered as market-standard data for trading a financial security in the odd lot market. OLP data are generated by incorporating one or more of the following various market-factors including, but not limited to, the price and volume of the evaluated trade, the same for recently-reported trades of the security to be evaluated, the same for any recently-reported trades similar to the trade being evaluated, the round-lot trade data and dealer quotes, security master data, interest rates, etc.

OLP data may include at least one of the three prices:
An Evaluated Price
An upper range price
A lower range price

Note that these prices in the OLP data can be with or without sales credit or mark-ups.

OLP data may be made specific to a security. For example, OLP data may be generated for each CUSIP, where a CUSIP is 9-character alphanumeric code that identifies a North American financial security.

Further, additional OLP data may be generated based on the quantity size. For example, for any given quantity, there will be one set of the OLP data. There may be provided multiple quantity-based buckets. As an example the buckets could be:
1-49 bonds
50-99 bonds
100-249 bonds
250-999 bonds

It is to be noted that the number of quantity-based buckets may change based on needs of the clients or to enhance the precision of the OLP prices. That is, the number of quantity-based buckets for generating OLP data is a flexible requirement that may be adjusted in a flexible manner prior to or during the implementation.

Further, OLP data may be generated in real-time incorporating the relevant market information at the time of the evaluation. OLP data may also be different depending on the evaluated position (e.g., buy or sell), trade-size, or any other characteristics of the trade or potential trade being evaluated.

The OLP data may be generated by an external server, after having sent to the external server relevant information of the trade or potential trade to be evaluated. Subsequently, the OLP data may be received from the external server and can be stored in a local server—e.g., Security Master or other appropriate data store—so as to make the OLP data accessible to various external functionalities such as a display function.

<OLP Use in Evaluating a Market Price>

Market participants can evaluate the odd lot market using the OLP data for various different purposes including, but not limited to evaluating a bid or an offer to be placed on a security in the odd-lot market.

FIG. 2 schematically shows an example of a process flow chart for evaluating a price quote on a security using OLP data, according to the present disclosure.

At step S210, a price to be evaluated for either a bid or an offer position on a security is received by a server. At step S220, the server checks whether the OLP data for the received security exists in the database. If there is no OLP data available, the server returns a result indicating that there is insufficient data regarding the identified security (S260). If the OLP data is available, the server checks whether the received price is within the OLP price range or even better than the OLP price range (S230). If the received price within or better than the OLP prices, then the server returns a result indicating that the price (e.g., the trade position being evaluated) is verified (S240). If not, the server returns a result indicating that the price (or the security or trade position being evaluated) needs further review (S250).

Various market participants may use this system—for example, a trader who is putting an offer in the market may check the offer against the OLP data to determine whether the offer falls within the market-acceptable range, or better than the market prices, falls outside the market price, before transmitting the offer to the trading platform. In other cases, a potential trader/buyer who is reviewing open quotes on a particular security may check each of the open quotes against the OLP data to see the respective market-acceptability of the open quotes.

The system may also allow users to see the actual OLP prices along with the results (S240, S250, S260) with tools to act on such information, as is explained in detail below.

One of the principal benefits of the OLP-integrated system is that it can display the OLP data in the context of the bid or offer price being evaluated by the user. When describing the alignment of a bid or offer price with the OLP, it may be better to use the offer or bid price exclusive of sales credit. Any additional Desk Markup or Wholesale Markup may or may not remain in the offer or bid price to be compared to the OLP.

As discussed above, the OLP may be made available in different quantities. Wherever the OLP is displayed; it should use the OLP related price/quantity that corresponds to the price to evaluated. For example, if an advisor is evaluating a quantity of 30 bonds to calculate the offering price, the OLP price related to the “50-99 bonds” bucket should be used. If the offering being displayed has less quantity available than the advisor's default quantity, obtain the OLP price from a smaller quantity bucket that correlates more appropriately.

Traders creating quotes may be provided with the OLP Range corresponding to the side (bid or ask) and the quantity being quoted.

The OLP may be displayed using any combination of text, icons and graphics. Text may be used to describe to the user whether the bid or offer price of a security is below, within or above the OLP Range.

Icons may be used to visually describe whether the bid or offer price is in alignment with the OLP, or if an OLP is not available.

One icon may be used to indicate that the bid or offer price is within or better than the OLP range. A different and distinct icon may be used to indicate that the bid or offer price is outside of the OLP range. Another different and distinct icon may be used to indicate that OLP is not available (there is insufficient data). Any other graphical representations may be used instead to indicate the respective results to the extent that it would be apparent to one of ordinary skill in the art in light of the teachings above.

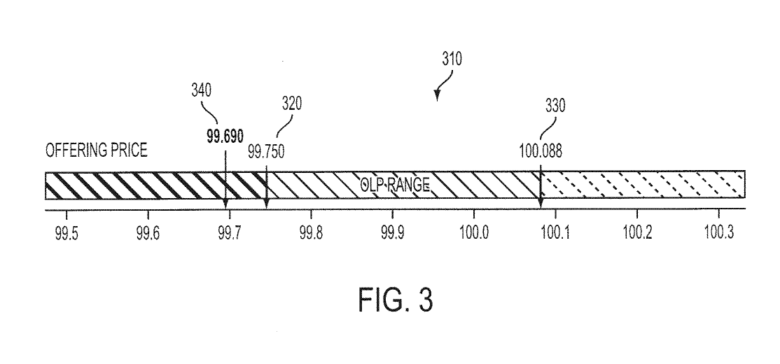

FIG. 3 shows an example of a graphic image of an OLP range that may be displayed in conjunction with an evaluated quote, according to the present disclosure.

The quoted price is for an offering price. After the quoted offering price is evaluated, a horizontal bar 310 is displayed on a displaying unit of the device used by a user. The horizontal bar displays the quoted offering price 340, upper range OLP price 330 and lower range OLP price 320. The quoted offering price 340 is lower than the lower range OLP price 320, and accordingly, is even better than the market-acceptable price range. The system will return a result indicating that the quoted offering price is verified.

Further, the horizontal bar 310 may be color-coded—for example, when the quoted price is an offering price, a portion of the bar indicating a price range below the upper range OLP price (330) may be displayed in green, indicating any offer price that falls in this range will pass the OLP test, and the other portion of the bar indicating a price range above the upper range OLP price (330) may be displayed in red, cautioning the viewer that any offer price in this range should be reviewed further.

A converse condition may apply when the quoted price is a bid price. For example, when the quoted price is a bid price, a portion of the bar indicating a price range above the lower range OLP price may be displayed in green, indicating any bid price that falls in this range is reasonable, and the other portion of the bar indicating a price range below the lower range OLP price may be displayed in red, cautioning the viewer that any bid price in this range should be reviewed further.

When OLP data is not available for a particular bid or offer price that is being evaluated, an appropriate graphic image indicating such result may be used, or no graphic image may be used at all.

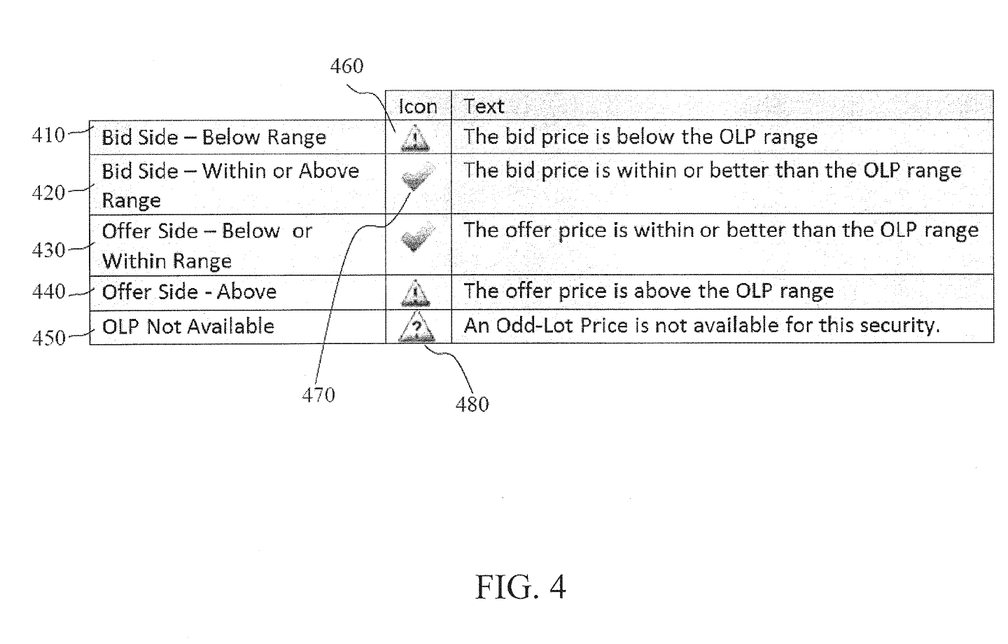

FIG. 4 shows an example of an evaluation table, with each evaluation result associated with a graphical representation, according to the present disclosure.

For a bid-side price quote to buy a security (see rows 410 and 420), if the quoted price is below the OLP range (e.g., below a lower range OLP price), the system returns a result indicating that the quoted price needs further review and may display an icon (e.g., 460). If the quoted price is within or above the OLP range (e.g., between an upper and lower range OLP prices or above the upper range OLP price), the system returns a result indicating that the quoted price is verified and may display a different icon (e.g., 470).

For an offer-side price quote to sell a security (see rows 430 and 440), if the quoted price is within or below the OLP range (e.g., between an upper and lower range OLP prices or below the lower range OLP price), the system returns a result indicating that the quoted price is verified and may display icon 470. If the quoted price is above the OLP range (e.g., above the upper range OLP price), the system returns a result indicating that the quoted price is needs further review and may display icon 460. If there is no OLP data (e.g., an upper and lower range OLP prices), the system returns a result indicating that there is insufficient data and may display a different icon (e.g., 480). Here, the respective graphical image of icons 460-480 is not critical to practice of the system, device, and method according to the present disclosure.

<Integration of Market Check and OLP Check>

“Market Check” is referred to a Pre-Trade price evaluation tool that compares the price of an offering to recent trade prices on that CUSIP. Financial advisors, brokers, or individual investors (user) are then warned of offering prices that need further review. Market Check may be combined with OLP Check (checking the offering price against the OLP range) to be made available on the search results display and also to be automatically run at the time of a transaction.

When a broker (a user) considers the purchase of a security, the market check functionality presents a real-time evaluation of the security's current pricing against TRACE/MSRB recently reported trades for that security. If the price appears to be out-of-line (for example, >3% or >4% for high-yield), a warning is presented to the user indicating that further investigation may be required. If the price is in line (for example, within 3% or within 4% for high-yield), the user is presented with a “verified” indicator.

OLP may be used in the determination of whether the user is presented with a “warning” or “verified” indicator. The lack of reported trade data or OLP will indicate that the price needs “further review” by the user or the user's firm's Trading Desk or the user's firm's compliance department.

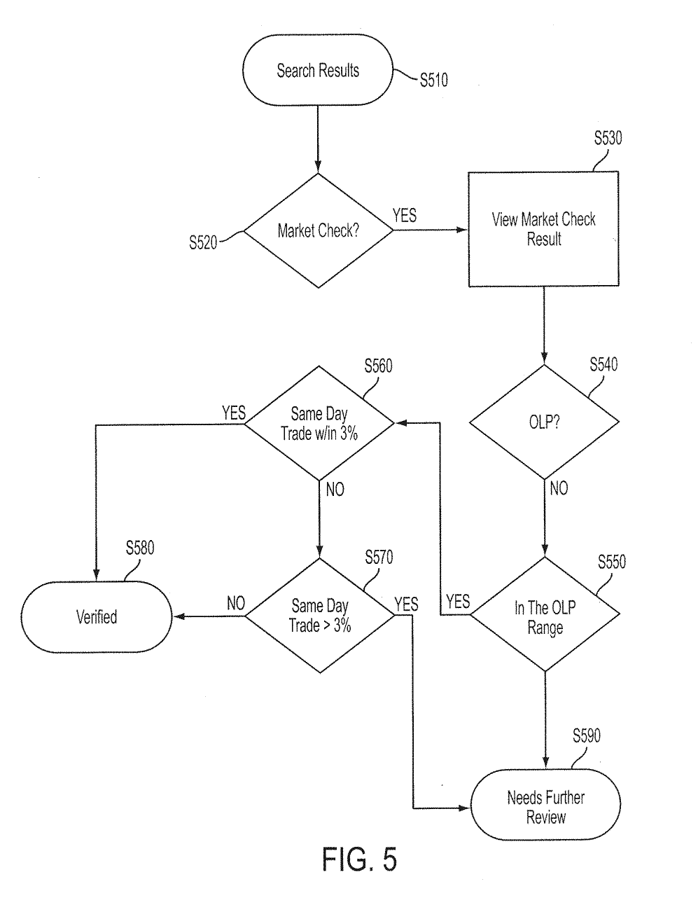

FIG. 5 schematically shows an example of a process flow chart for integrating OLP data with market check functionality, according to the present disclosure.

At S5510, a user receives a search result on a particular security, which may be identified by a CUSIP.

At S5520, the market check is performed by evaluating recently-reported trades on the same CUSIP or similar CUSIP. The result is returned at S530. After the market check is done, the system moves to step S540 to perform the OLP check. If there is insufficient data on the recently-reported trades and consequently no result can be returned from the market check, the system moves directly to step S540. Either or both the market check at S520 and the OLP check at S540 may be performed in response to a user's command (inputted via an input device) or may be automatically performed even without a user's command depending on implementation design requirements of the system. An input device may be any peripheral device including any piece of computer hardware equipment that may be used to receive data from a user and provide the data and control signals to an information processing system such as a processor. Examples of input devices may include keyboards, mice, scanners, cameras, joysticks, etc.

At S550, it is determined whether the quoted price being evaluated is in the OLP range. The definition of a price being within an OLP range or outside an OLP range may follow the description made above with respect to FIG. 2. Any other definition may be used instead depending on, for example, the design needs and user-inputted criteria.

If the quoted price is not in the OLP range, the system returns a result indicating that the quoted price (and the quoted security, trade or potential trade being evaluated) needs further review (S590).

If the quoted price is in the OLP range, it is next determined based on the market check result whether there has been any trade executed on the same day with an executed price being within 3% tolerance of the quoted price (S560). If there has been any such trade, the quoted price is verified (S580). If there has not been any such trade, it is next determined whether there has been any trade executed on the same day with an executed price being outside the 3% tolerance of the quoted price (S570). If there has been any such trade, then the quoted price needs further review (S590). If there has not been such trade, the quoted price is verified (S580).

The 3% tolerance value is provided only as an example, and any tolerance value may be used instead such as any value less than 30%, 20%, 15%, 10%, 7%, 5%, 3%, 2%, etc, depending on user needs. Further, instead of evaluating only the trades executed on the same day, the market check may evaluate trades that have been executed within a predetermined number of past days—e.g., within past 30 days, 25 days, 20 days, 15 days, 10 days, 7 days, 5 days, 3 days, 2 days, etc—depending on user needs. In fact, each of these values is a factor that is modifiable or adjustable by a user prior to or during use of the system.

<Market Check Icons and Display with OLP>

The pre-trade evaluation (market check) and the OLP comparison results may be used together to determine an ultimate evaluation result of a quoted price or a quoted transaction.

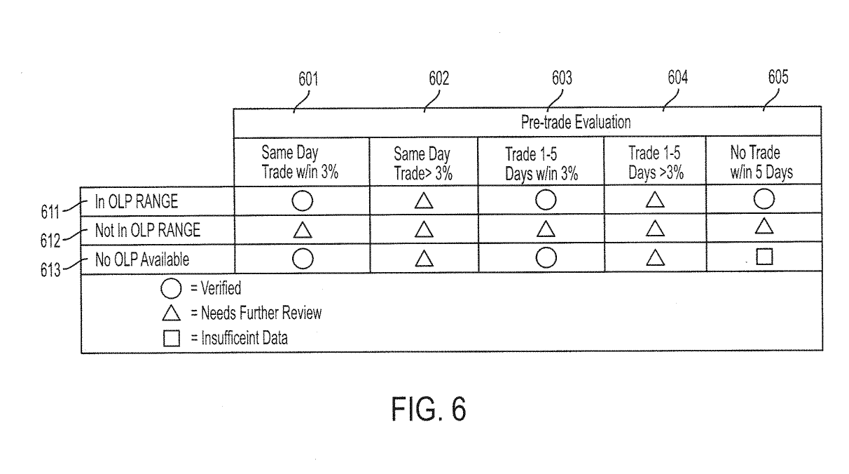

FIG. 6 shows an example of an evaluation table based on results from both the market check and OLP check, according to the present disclosure.

For conditions 601 and 611, the market check returns that that there has been a same-day trade within 3% tolerance of the quoted price, and the quoted price is in the OLP range. Then, the final evaluation result is returned as the quoted price is verified.

For conditions 602 and 611, the market check returns that that there has been a same-day trade but outside the 3% tolerance of the quoted price, and the quoted price is in the OLP range. Then, the final evaluation result is returned as the quoted price needs further review.

For conditions 603 and 611, the market check returns that that there is no same-day trade but there has been a trade executed within past one to five days within 3% tolerance of the quoted price, and the quoted price is in the OLP range. Then, the final evaluation result is returned as the quoted price is verified.

For conditions 604 and 611, the market check returns that that there is no same-day trade but there has been a trade executed within past one to five days but outside the 3% tolerance of the quoted price, and the quoted price is in the OLP range. Then, the final evaluation result is returned as the quoted price needs further review.

For conditions 605 and 611, the market check returns that that there is no trade executed within past one to five days on the security being evaluated, and the quoted price is in the OLP range. Then, the final evaluation result is returned as the quoted price is verified.

When condition 612 applies (i.e., the quoted price is not in the OLP range), regardless the pre-trade evaluation result (i.e., market check result, or evaluation on the recently-reported trades) the final evaluation result is returned as the quoted price needs further review.

When condition 613 applies (i.e., no OLP data available), the final result will be based on only the pre-trade evaluation result (i.e., market check result, or evaluation on the recently-reported trades). For conditions 613 and 605 when there is no available OLP data or recently-reported trade data, the final result is returned as there is insufficient data to take a position on the quoted transaction.

<Market Check Hover with OLP>

Wherever Market Check appears, a user can mouse-over the icon to receive a hover with detailed information on the evaluation performed on a particular security. For example, the OLP information may appear just beneath the Pre-Trade Evaluation. Pre-Trade information and OLP may appear for both bid and ask side markets.

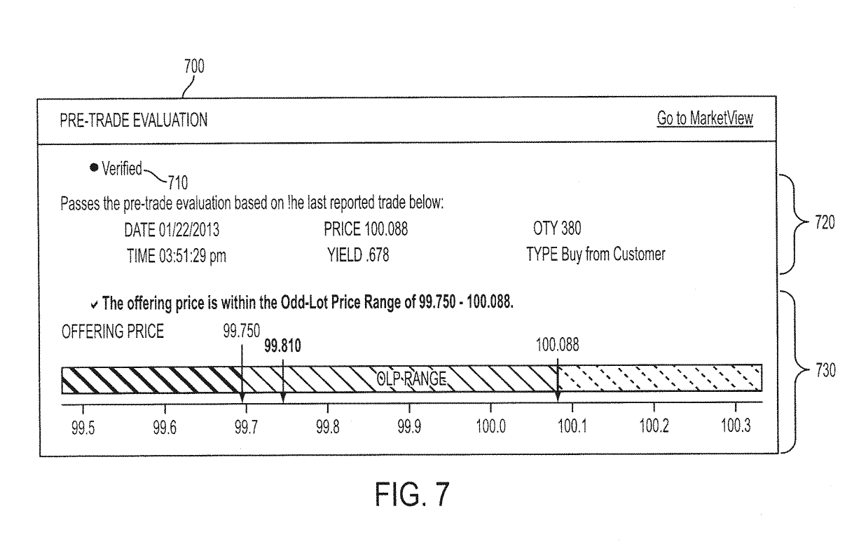

FIG. 7 shows an example of a screen displaying at least one of a OLP check result, a market check result and an evaluated quote, according to the present disclosure.

The hover screen 700 includes the final evaluation result, the market-check result and the OLP check result. The final evaluation result indicating that the offering price is verified may be displayed using an icon and associated text as shown in 710. The information on the most relevant recent trade may be displayed beneath the final evaluation result as shown in 720. The information on the OLP range and the offering price may next be displayed, as shown in 730.

<Applied Uses of OLP>

Any one or more of the features described above in relation to OLP may be applied to any one or more of the following applications:

i. Security Offering Search Results

When searching for fixed-income securities to purchase or sell, a financial advisor can consult the Market Check/OLP evaluation applicable to that security.

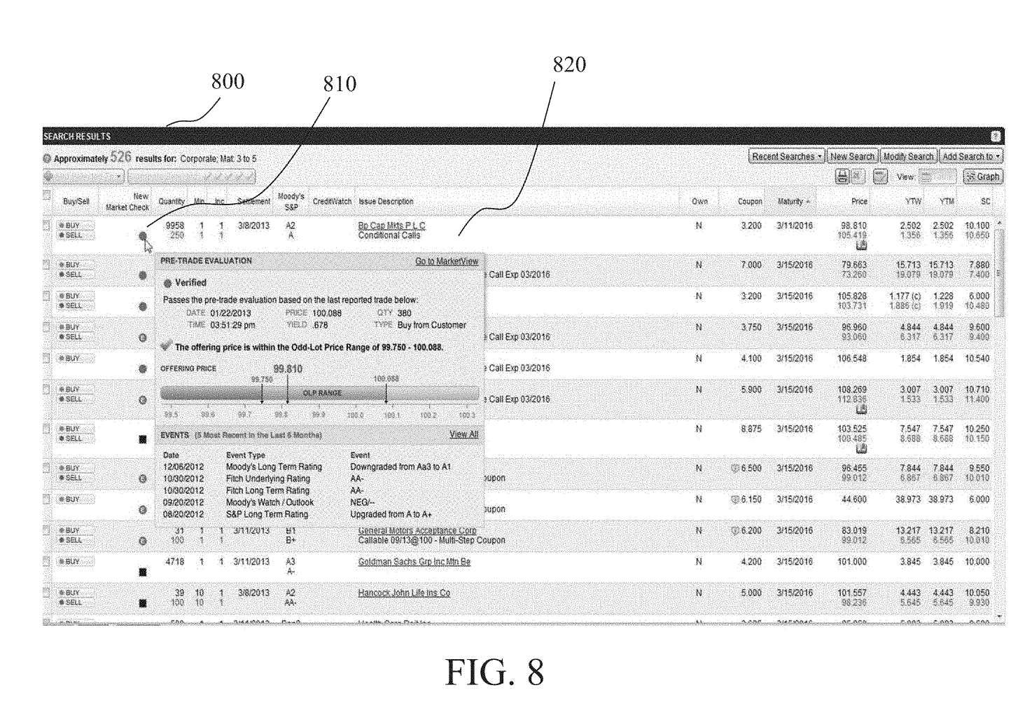

FIG. 8 shows an example of a screen displaying a bond-offering search result with at least one of a OLP check result, a market check result and an evaluated quote, according to the present disclosure.

The hover screen 820, reflecting the market check result and the OLP check result, is integrated into the bond-offering search result screen 800. When a user is researching which bond to purchase, he or she can interact with the OLP in the market check column 810 to determine whether the offer price is in the OLP range. This provides an efficient and easy way to inform the user whether the price the user may be purchasing the bond at is at a market reasonable price.

ii. Buy/Sell Orders and Bid/Offer Wanted Request Blotter for Traders and Liaison Traders

Orders and Bid/Offer Wanted requests by advisors are typically routed to liaison traders or traders for review before being released to the market place. The market place may be an alternative trading system (ATS) but may be any other similar system that provides a trading venue to match buyers and sellers.

These liaison traders or traders will be provided with OLP to assist in price validation. Similarly, liaison traders or traders intermediate responses received from the ATS to Bid/Offer Wanted requests placed by Financial Advisors, brokers, or individual investors within their company or their customers and these messages will likewise be enhanced with OLP data to assist in price validation.

iii. Dealer Quotes and Bid/Offer Wanted Responses

Dealers creating quotes and responding to requests for quotes will likewise be provided OLP data. The icons and rollovers will be available to Liquidity providers utilizing the online interfaces. The OLP pricing data and/or warning text or an indicator as to whether an order is in the OLP range or not may be provided thru Application Programming Interfaces (APIs).

iv. Market Check I OLP

The icons indicating the market check and OLP evaluation results may be presented on the Trader's blotter when there is an order awaiting approval or for any open auction and Bids/Offers exist.

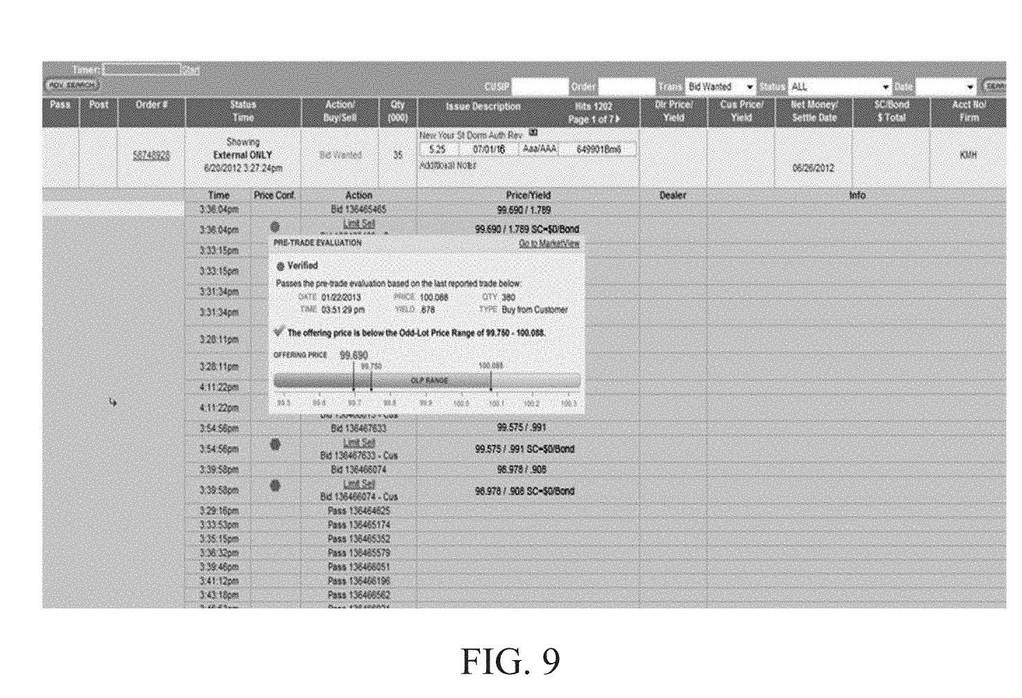

FIG. 9 shows an example of a screen displaying a list of one or more of quotes with at least one of a OLP check result, a market check result and an evaluated quote, according to the present disclosure.

For each open auction or buy/sell entry, an icon and a hover screen are provided to indicate whether the respective entry passes the market check and the OLP check. This screen may be implemented, for example, for liaison traders' view.

v. Security (e.g., Bond) Information

To aid a financial advisor, broker, or an individual investor in a buy or sell decision when reviewing the details of a security, the Market Check/OLP may be made available.

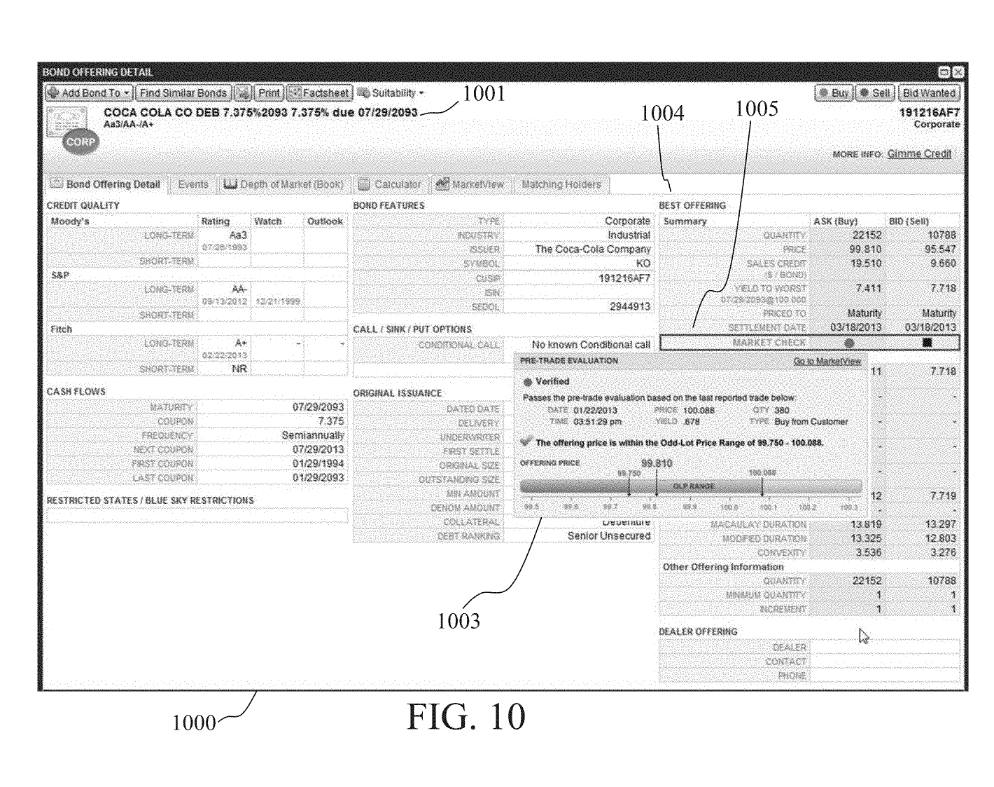

FIG. 10 shows an example of a screen showing the market check and OLP check results as part of a detail-view on a particular security, according to the present disclosure.

The screen (1000) is displaying a detailed view on the COCA COLA CO DEB bond (1001). This view displays, inter alia, information on a best offering available in the market (1004) for both buy and sell sides. For each best offer, the market check information is provided through an icon or any equivalent (1005). There may be provided a hover screen (1003) displaying further information on the market check results and the OLP check results. For example, the best offering price on the buy-side is verified (1500). Also, there has been a recently-reported trade of the COCA COLA CO DEB bond, which was executed on Jan. 22, 2013 with the price of 100.088, and this best offering price (99.810) is within the OLP range, as shown in hover screen 1300.

vi. Order Ticket Preview/Confirmation

An OLP evaluation will run in the background at order preview time and display a message to the Financial Advisor, broker, trader, liaison trader, or individual investor (the user placing the order) when the evaluation results in “Needs Further Review”.

vii. Market View

Market View price discovery tool may aid Financial Advisors, brokers, traders, liaison traders, or individual investors in evaluating bond prices within the context of prevailing market conditions. The chart available in Market View is enhanced with an OLP evaluation, providing users with indications of what a fair price would be for the security they are reviewing.

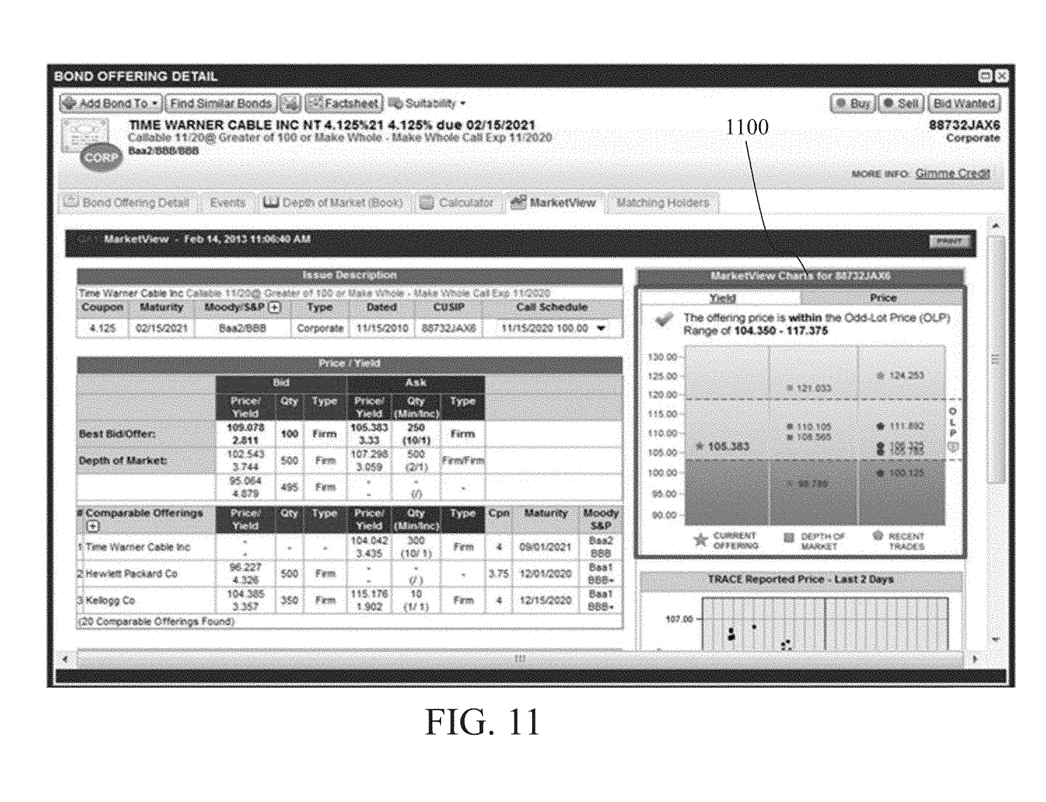

FIG. 11 shows an example of a Market View screen that graphically represents the current offering, depth of market, recent trades, and OLP range, according to the present disclosure.

The screen 1100 displays the current offering (star), the depth of market including currently open offer prices (rectangle), and the recently-reported trades (pentagon). The OLP range is shown in the graph. The final evaluation result indicating the current offering price is verified is shown above the graph through an icon and associated text.

viii. Trade Monitoring Service (TMS)

There may be provided a new TMS test for OLP. This new test will compare the customer execution price against the OLP and its range. First the range should be selected for the bucket that the order size falls into. Then, the customer inputs a bid or offer price.

If the customer-expectation price is within the OLP range, the customer-expectation price will pass the TMS test. For a customer on the sell-side, if the customer-expected price is within the OLP range or higher than the maximum value of the OLP range, the customer-expected price will pass the TMS test, and the user may be notified accordingly. For a customer on the buy-side, if the customer-expected price is within the OLP range or lower than the minimum value of the OLP range, the customer-expected price will pass the TMS test, and the user may be notified accordingly.

On the other hand, if the customer-expected price is not within the OLP range, the customer-expected price will be flagged as an exception to the market range. For a customer on the sell-side, if the customer-expected price is lower than the minimum value of the OLP range, it will be flagged as an exception, and the user may be notified accordingly. For a customer on the buy-side, if the customer-expected price is higher than the maximum value of the OLP range, it will be flagged as an exception, and the user may be notified accordingly.

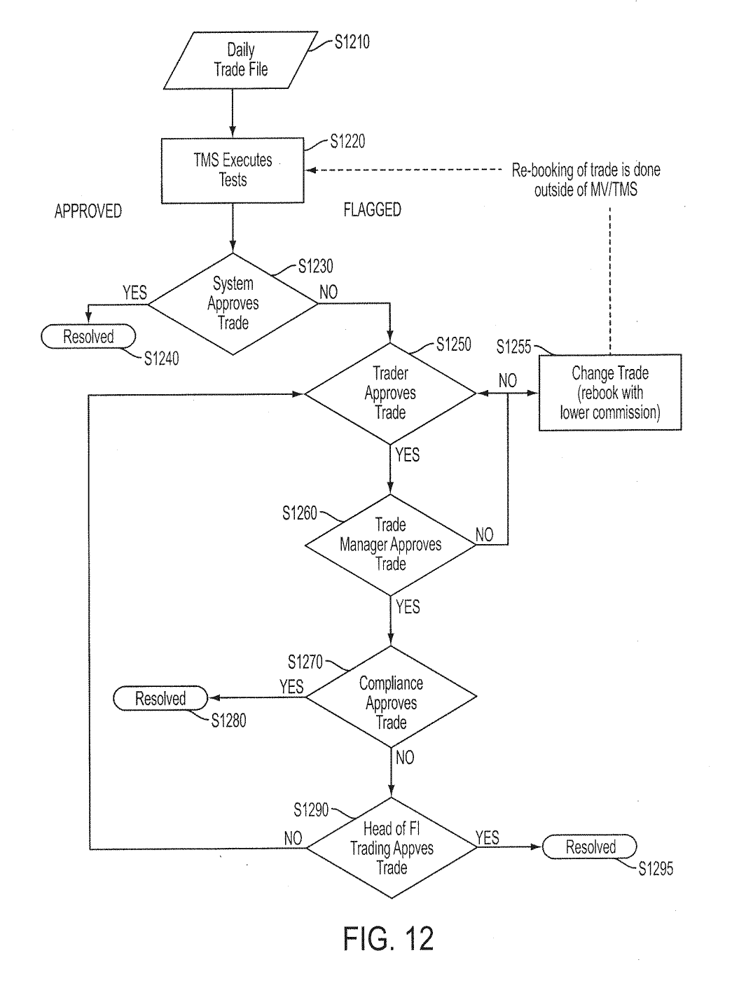

FIG. 12 shows an example of a process flow chart for integrating the OLP check into Trade Monitoring Service (TMS) test, according to the present disclosure.

At S1210, the user pulls the relevant daily trade file for the trades that the user wishes to execute TMS on. At S1220, the trade monitoring system (TMS) automatically executes either or both the market check test and OLP test on the customer-quoted trade. If the system approves the trade (S1230), the trade is validated (S1240).

If the system does not approve the trade, at least in part because the quoted-trade does not pass either or both the market check test and the OLP test, the system may transfer the trade information to trader's desk for the trader's approval (S1250).

At S1250, if the trader approves the quoted trade, the system may transfer the information to trader's manager's desk for the manager's approval (S1260). If the manager approves it, the system may transfer the information to compliance person for compliance's approval (S1270). If the compliance approves it, the trade is validated (S1280).

At S1250, if the trader does not approve the quoted trade, the system allows the trader to change offering characteristics of the trade (for example, rebooking with a lower commission), as done in S1255. Once the rebooking is done, the TM8 executes either or both the market check and OLP tests on the rebooked trade (S1220) and repeats the process.

At S1260, if the trader's manager does not approve the original trade, the system opens the rebooking option as explained above for S1255.

At S1270, if the compliance does not approve the original trade, the system may transfer the trade information to the head of fixed income trading for his/her approval. If the trading head approves the trade, the trade is validated (S1295). If the head does not approve the trade, the system opens the rebooking option as explained above for S1255.

The test executed by the TM8 may be called “Odd Lot Price Range (test).” If the trade is flagged as an exception (e.g., fails the test), then the system may display the high and low values of the OLP range, indicate the variance from the low (for a customer on the sell-side) and from the high (for a customer on the buy-side), and identify the test number. It may not be re-queued.

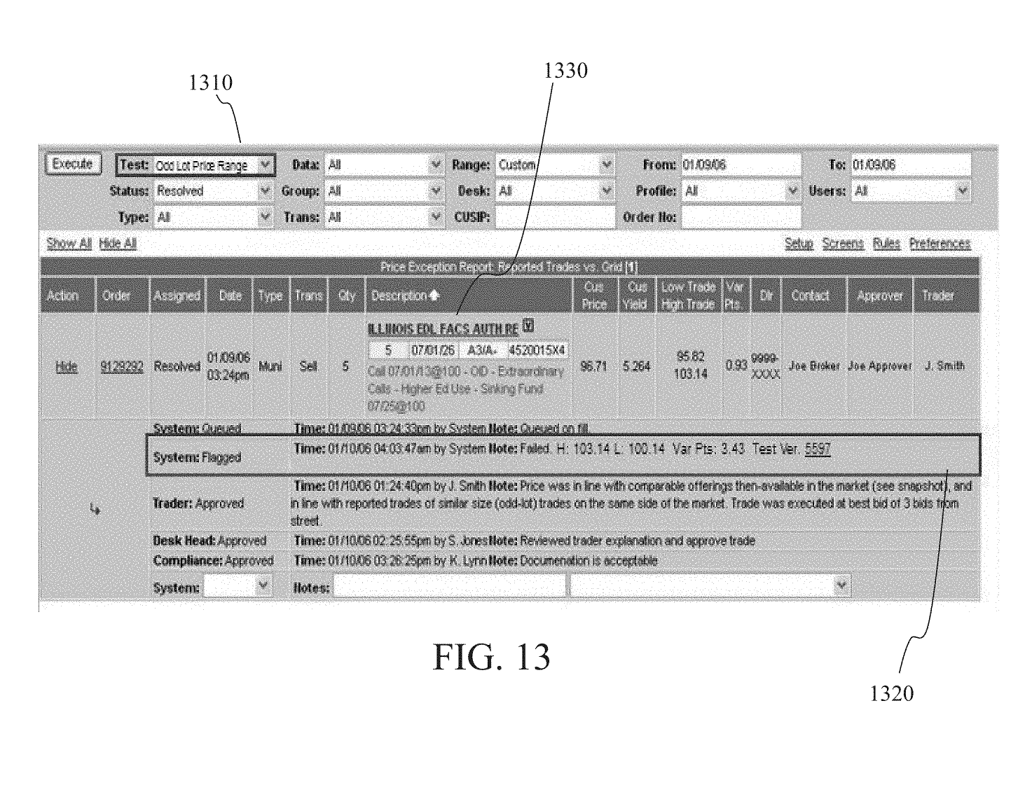

FIG. 13 shows an example of a screen that may be displayed to indicate a ‘failed’ status of the Odd-Lot Price Range test, according to the present disclosure.

The test being executed is identified in box 1310 as the Odd Lot Price Range test. The test result indicated in box 1320 displays that the quoted trade identified in box 1330 has failed the test. It displays the time of the test execution, the test result, the high and low values of the OLP range, the variance, and the test version, as shown in box 1320. A similar display may be used when the test passes. When the test passes, the display may omit information on the test version.

ix. Liquidity Providers and Trader Workflows

Liquidity providers may be provided OLP in a similar manner explained above with regard to applications for traders, financial advisors, etc. Accordingly, the user interface implementations for the OLP range, test results, etc, may be similar to the ones explained above.

When dealers send quotes or respond to bid/offer wanted requests, the OLP system may validate the dealer's input price against the OLP Range and update the user interface with an icon to indicate whether the price is within the Range or not. The dealer may update the input price to fall within the Range or validate the price the input price against other markets and sources and maintain the input price if desired.

When sending quotes and responding to bid/offer wanted requests, dealers may receive a message with the OLP data and text after their quote or response has been successfully saved to the platform. If desired, the dealers may update their quotes and responses after their review of the OLP data.

x. Posting Quotes

Liquidity providers may also create quotes using a number of online and API tools—for example, Offering SetUp, Position Manager and Single Offering SetUp are online interfaces used to post quotes. The OLP system may be integrated with each of these interfaces so that the OLP range, icon and text indicating whether the Offering Price is within the range or not are displayed in real-time.

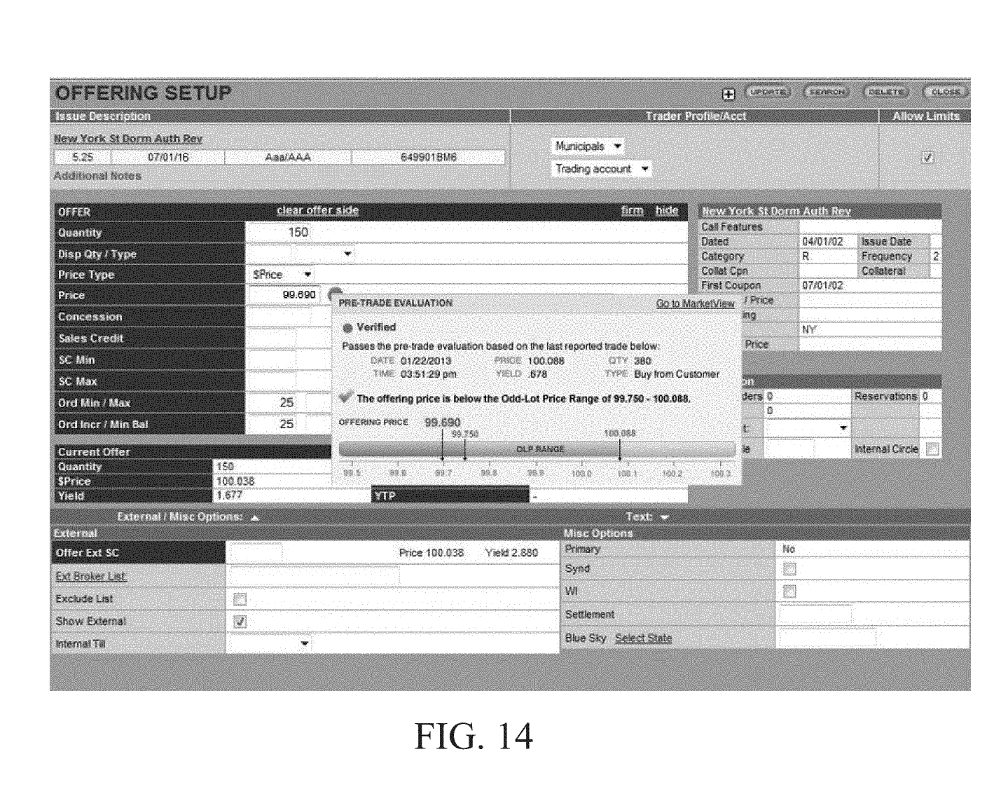

FIG. 14 is an example of a screen of an offering setup that allows posting a quote with OLP demonstrated.

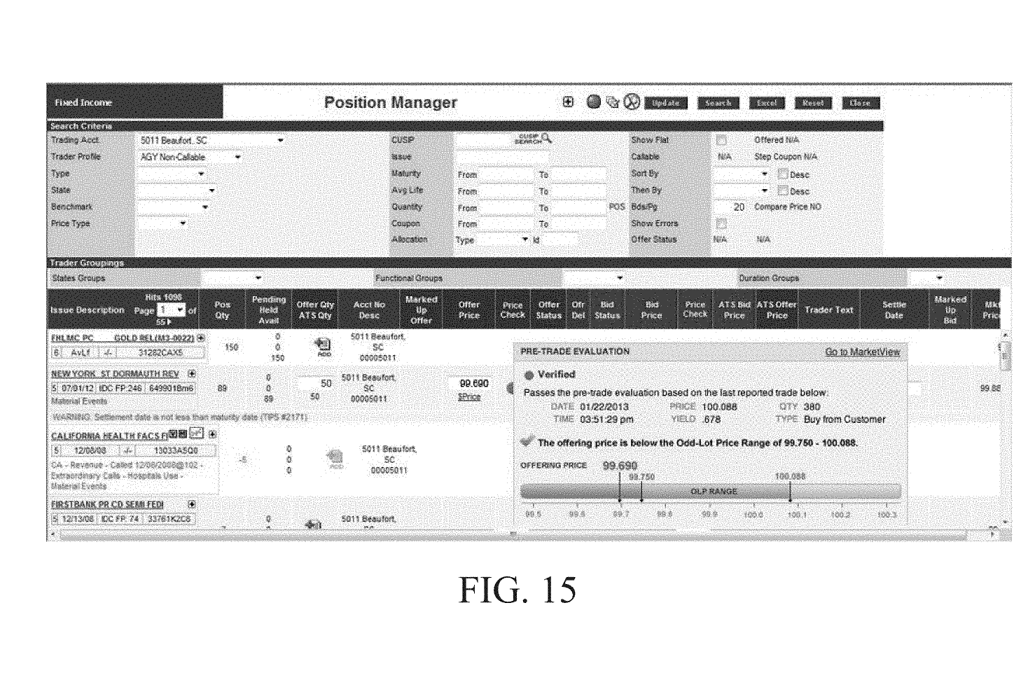

FIG. 15 is an example of a screen for a position manager that allows reviewing and posting a quote with OLP demonstrated.

Since the system according to the present disclosure allows a user to verify the offering price prior to posting it, the user may have a greater confidence in the offering price.

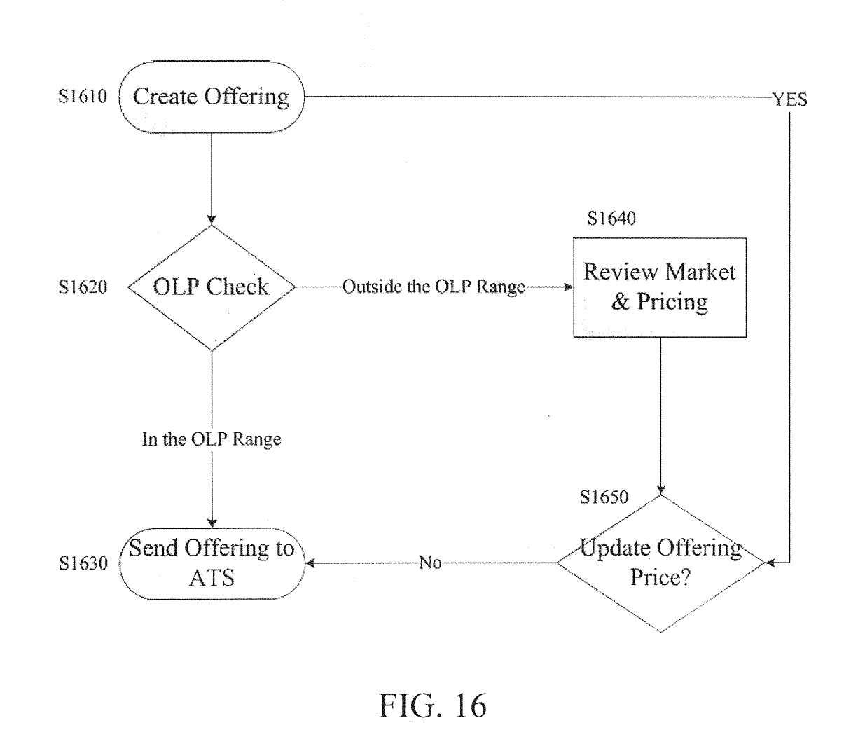

FIG. 16 shows an example of a process flow for setting up an offering with use of the OLP check feature.

At S1610, a user creates an offering. At S1620, the system automatically executes the OLP check test, which may include the market check test explained above. If the offering price is in the OLP range, the offering is approved and sent to the market place (e.g., ATS) at S1630. If the offering price is outside the OLP range, the system allows the user to review the relevant market and pricing at S1640 and subsequently provides an option to update the offering price at S1650.

Here, the offering price may include any characteristics of the offer including but not limited to the actual offer price, offer size, commission, etc. If the offering is updated, then the system repeats the check from S1610. If the offering is not updated (e.g., the user denies to update the offer), it works as the user's confirmation that the offering price as is may be sent to the ATS.

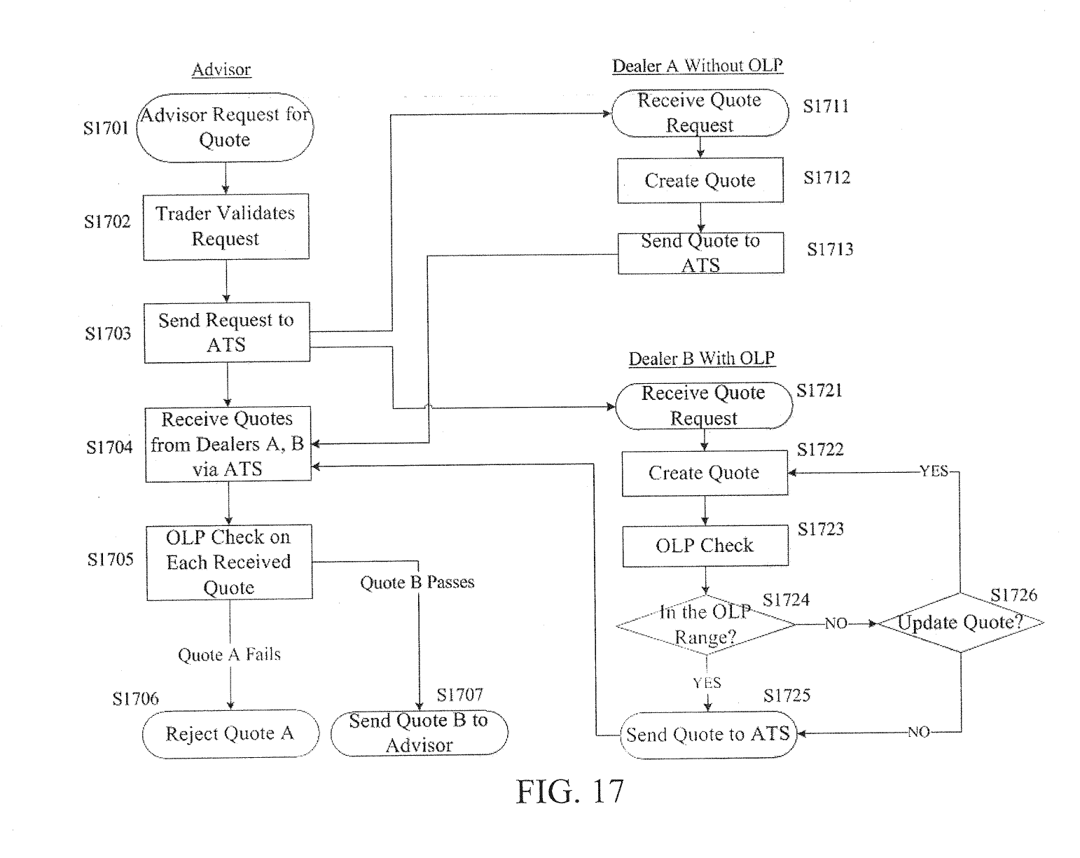

FIG. 17 shows an example of a process flow chart for requesting for a quote and responding to the request from multiple dealers.

At S1701, the advisor requests for a quote on a security. At S1702, the trader validates the request. At S1703, the request is sent to the market place (e.g., ATS) and thereby posted. This request is viewed by potential dealers including dealer A and dealer B through the market place (S1711 and S1721). At S1704, the advisor-side system receives quotes (bids) from dealer A and dealer B through the market place (e.g., ATS).

At S1705, the system automatically performs the OLP check on each of the quotes received. The quote from dealer A fails the OLP test whereas the quote from dealer B passes the test. Here, the OLP test may include either or both the OLP test (comparing the quoted price against the OLP range) and the market check test (accounting the recently-reported trades), as previously explained above. The system may automatically reject the Quote A (S1706), and send only the Quote B to the advisor for review and approval for accepting (S1707).

On the dealer side, dealer A uses a conventional system without the OLP functionalities according to the present disclosure. At S1711 and S1712, dealer A receives the advisor's request for a quote and creates a quote. Without being able to verify market-acceptability of the quote using OLP functionalities, the quote from dealer A is sent to the ATS (S1713) and ultimately gets rejected for being off the market by the advisor's system (S1706).

On the other hand, dealer B uses a system with the OLP functionalities according to the present disclosure. At S1721 and S1722, dealer B similarly receives the advisor's request for a quote and creates a quote. However, unlike dealer A, dealer B verifies the market-acceptability of its quote using the OLP functionalities (S1723). If the quote is in the OLP range (in the market acceptable price range) (S1724), then the quote is sent to the ATS (S1725). If the quote is outside the OLP range (outside the market acceptable price range), then the dealer B's system gives an option to update the quote (S1726). If the quote is updated, the updated quote goes through the same OLP check again (S1722). If the quote is not updated (e.g., dealer B denies to update the quote that is currently being outside the OLP range), this operates as a confirmation that the quote as is may be sent to the ATS. Since dealer B can predict and control expected market acceptability of its quote, dealer B's quote is more likely going to be accepted by the advisor (S1707).

Using any of the embodiments according to the present disclosure, a trader who is setting up an offer for an odd lot trade of a security may check, prior to posting his/her offering, how his/her price will be evaluated against the OLP range before posting his/her price because other market participants that might be considering acting upon his/her offer (financial advisors, brokers, individual investors) are evaluating its price by using the OLP range. If the trader's offer price is within or better than the OLP range, the trader will have a higher likelihood of another market participant acting upon his/her offer and generating a trade. This is advantageous because the goal of a trader creating an offering is usually to generate a trade.

On the other hand, a financial advisor who may be considering purchasing a security may check, prior to making his/her purchasing decision, whether the price of an offering they are considering purchasing is within or better than the OLP range then it is unlikely that a trade at that offering price will get rejected by the financial advisor's liaison trader as being off the market. This is advantageous because financial advisors do not generally want trades to get rejected since they typically have spent a fair amount of time convincing their customer to do the trade.

The OLP system according to an embodiment of the present disclosure may allow all of the market participants to have the opportunity to utilize the same OLP range for a particular security—only one OLP range per security at any given time will exist, and this single OLP range will be considered a measure of price quality for that particular security. This results in leveling the playing field between market participants and thereby providing market confidence. In other words, OLP may arm all parties to the transaction with the same independent evaluation of pricing quality.

However, the above feature is merely one exemplary embodiment and not a requirement to the practice of the present disclosure. As explained above with reference to at least one of the foregoing embodiments, the OLP system according to the present disclosure may be designed and/or implemented in accordance with any particular design needs—for example, the system may be designed so that only one of the participant types (advisors/brokers for example) have access to the OLP range, etc.

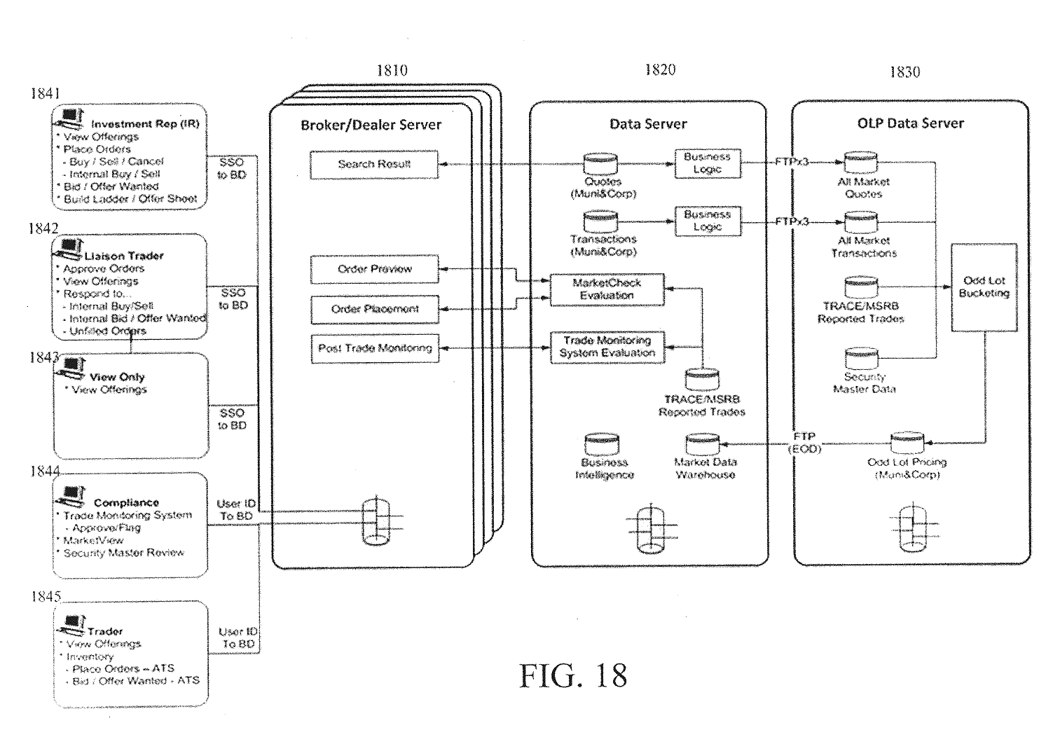

FIG. 18 schematically shows an example of an odd lot retail pricing system, according to the present disclosure.

The odd lot retail pricing system may be attractive to various market participants that may non-exclusively include investment representatives (1841), liaison traders (1842), view-only traders (1843), compliance people (1844), and regular traders (1845). Each of these participants has access to broker/dealer server (1810). There is one or more of the broker/dealer servers (1810), and the market participants (1841˜1845) has access to their respective broker/dealer server.

Each of the broker/dealer server (1810) may then have access to data server (1820). The data server (1820) processes quotes for securities including municipal and corporate bonds, performs the market check evaluation based on the recently-reported data pulled from TRACE/MSRB, performs the trade monitoring system (TMS) evaluation, and performs the OLP test.

The data server (1820) receives OLP data, which is necessary to perform the OLP test, from OLP data server (1830). The OLP data server (1830) generates OLP data based on at least all market quotes, all market transaction, all recently-reported trade data pulled from TRACE/MSRB, and security master data. The OLP data server (1830) also accounts different odd-lot bucket sizes before generating final OLP data for any particular security being evaluated. The OLP data server (1830) may be installed and operated by a third party—in other words, the data server (1820) and OLP data server (1830) may be operated by different parties.

From the foregoing it will be appreciated that, although specific embodiments of the OLP system according to the present disclosure have been described herein for purposes of illustration, various modifications may be made without deviating from the spirit and core principle of the disclosure.

1. A system for providing odd lot pricing evaluation of a security, the system comprising one or more processors and a memory storing one or more programs that, when executed by the one or more processors, cause the one or more processors to perform instructions comprising:
receiving, from a user device, a quote inputted by a user into a user interface displayed on the user device, wherein the quote is associated with an odd lot transaction or a potential transaction of a security and the quote comprises a quoted price and a quoted quantity;
in respond to receiving the quote, searching a database of Odd Lot Pricing (OLP) ranges to select an OLP range associated with the quoted quantity;
comparing the quoted price against the OLP range to determine a result indicating whether to verify the quote; and
in response to comparing the quoted price against the OLP range, transmitting the result to the user device; and
causing the user device to: display, in the user interface, an icon indicating whether the quote is verified, and upon receiving a selection from the user of the icon, display a graphical representation showing a range of prices, wherein the graphical representation includes a first graphical indicator representing the OLP range and a second graphical indicator representing the quoted price in association with the first graphical indicator.

2. The system of claim 1, wherein the icon indicates that the quote is verified if the quoted price is within the OLP range.

3. The system of claim 1, wherein the icon indicates that the quote needs further review if the quoted price is outside the OLP range.

4. The system of claim 1, wherein the icon indicates that there is insufficient data regarding the quote if no OLP range is available with regard to the quote.

5. The system of claim 1, wherein
the quoted price is an offer price to sell the security,
the quoted price is within the OLP range if the quoted price is lower than the lower range price of the OLP range, and
the quoted price is outside the OLP range when the quoted price is higher than the upper range price of the OLP range.

6. The system of claim 1, wherein
the quoted price is a bid price to buy the security,
the quoted price is within the OLP range if the quoted price is higher than the upper range price of the OLP range, and
the quoted price is outside the OLP range when the quoted price is lower than the lower range price of the OLP range.

7. The system of claim 1, wherein the programs, when executed by the one or more processors, further cause the one or more processors to:
obtain trade data of odd lot transactions associated with the security and executed within a predetermined number of days from when the quoted price is received; and
determine the result based on the trade data.

8. The system of claim 7, wherein the icon indicates that the quote is verified if any one of the following conditions is satisfied:
(i) the quoted price is within the OLP range and the trade data include information regarding a trade executed within a predetermined tolerance of the quoted price,
(ii) the quoted price is within the OLP range and there is no trade executed on the same day when the quoted price is received,
(iii) the quoted price is within the OLP range and the trade data includes information regarding a trade executed within the predetermined number of days from when the first price quote is received, which was executed within the predetermined tolerance of the quoted price,
(iv) the OLP range is not available and the trade data includes information regarding a trade executed on the same day and within the predetermined tolerance of the quoted price, or
(v) the OLP range is not available and the trade data includes information regarding a trade executed within the predetermined number of days and within the predetermined tolerance of the quoted price.

9. The system of claim 7, wherein the icon indicates that the quote needs further review if any one of the following conditions is satisfied:
(i) the quoted price is outside the OLP range,
(ii) the quoted price is within the OLP range and the trade data includes information regarding a trade executed on the same day whose executed price is outside a predetermined tolerance of the quoted price,
(iii) the quoted price is within the OLP range and the trade data includes information regarding a trade executed within the predetermined number of days from when the quoted price is received, which were executed outside the predetermined tolerance of the quoted price,
(iv) the OLP range is not available and the trade data includes information regarding a trade executed on the same day outside the predetermined tolerance of the quoted price, or
(v) the OLP range is not available and the trade data includes information regarding a trade executed within the predetermined number of days outside the predetermined tolerance of the quoted price.

10. The system of claim 7, wherein the icon indicates that there is insufficient data to make the determination as to whether the quote is verifiable when no available trade data of odd lot transactions executed within the predetermined number of days from when the quoted price is received.

11. The system of claim 7, wherein the result is determined based on whether the quoted price is within a predetermined tolerance of one or more executed quotes, and wherein the predetermined tolerance is less than 10% the predetermined number of past days is less than 10 days, and each of these values is configurable by the user.

12. The system of claim 1, wherein the OLP range for is generated based on at least one of round-lot trade data, dealer quotes, security master data, and yield curves.

13. The system of claim 1, wherein the programs, when executed by the one or more processors, further cause the one or more processors to:
transmitting, to a server, information regarding the quote including the quoted price; and
receiving, from the server, the OLP range for the quote calculated by the server.

14-15. (canceled)

16. The system of claim 1, wherein at least one of the result and the OLP range, is transmitted on an API or as a network message.

17-24. (canceled)

25. The system of claim 1, wherein the user device is configured to display the graphical representation in a hover screen.

26. The system of claim 1, wherein the graphical representation comprises a horizontal bar, wherein the first graphical indicator marks a portion of the horizontal bar to indicate the OLP range, and wherein the second graphical indicator depicts the quoted price in association with the horizontal bar.

27. A non-transitory computer-readable storage medium comprising one or more programs that when executed by a server having one or more processors cause the one or more processors to perform instructions comprising:
receiving, from a user device, a quote inputted by a user into a user interface displayed on the user device, wherein the quote is associated with an odd lot transaction or a potential transaction of a security and the quote comprises a quoted price and a quoted quantity;
in respond to receiving the quote, searching a database of Odd Lot Pricing (OLP) ranges to select an OLP range associated with the quoted quantity;
comparing the quoted price against the OLP range to determine a result indicating whether to verify the quote; and
in response to comparing the quoted price against the OLP range, transmitting the result to the user device; and
causing the user device to: display, in the user interface, an icon indicating whether the quote is verified, and upon receiving a selection from the user of the icon, display a graphical representation showing a range of prices, wherein the graphical representation includes a first graphical indicator representing the OLP range and a second graphical indicator representing the quoted price in association with the first graphical indicator.
